(19) United States
(12) Patent Application Publication
(10) Pub. No.: US 2026/0029777 A1
(43) Pub. Date: Jan. 29, 2026

(54) INERTIA ESTIMATION APPARATUS, INERTIA ESTIMATION METHOD, AND MOTOR CONTROL APPARATUS

(71) Applicant: OKUMA Corporation, Niwa-gun (JP)

(72) Inventors: Satoshi SUMI, Niwa-gun (JP); Takeshi SAKAI, Niwa-gun (JP); Masahiro MAEDA, Niwa-gun (JP)

(21) Appl. No.: 19/278,064

(22) Filed: Jul. 23, 2025

(30) Foreign Application Priority Data
Jul. 23, 2024 (JP) 2024-118053

(51) Int. Cl. G05B 19/4155

(52) U.S. Cl. CPC G05B 19/4155; G05B 2219/34013

(57) ABSTRACT

An inertia estimation apparatus that estimates the inertia of a movable portion including a motor, a gearbox, and a member to be driven includes a controller configured to estimate the inertia of the movable portion based on an acceleration a and an output torque τ of the motor, and a gear ratio R (R=m/n), which is a ratio of an output-side velocity m with respect to an input-side velocity n, of the gearbox when the motor is caused to perform an acceleration/deceleration operation for estimating inertia. The controller is configured to cause execution of the acceleration/deceleration operation for estimating the inertia in a state in which the gear ratio R is changed to a gear ratio for estimating inertia.

### CROSS REFERENCE TO RELATED APPLICATION

The present invention claims priority under 35 U.S.C. § 119 to Japanese Patent Application No. 2024-118053 filed on Jul. 23, 2024, the entire contents of which being incorporated herein by reference.

### TECHNICAL FIELD

The present disclosure relates to an inertia estimation apparatus that estimates the inertia of a movable portion including a motor, a gearbox, and a member to be driven, an inertia estimation method, and a motor control apparatus.

### BACKGROUND

Many techniques have been proposed in the related art for controlling, with high precision, the position or velocity of a member to be driven which is driven by a motor. For example, in machine tools, a spindle and a workpiece which is attached to the spindle are treated as the member to be driven, and the position or the velocity thereof must be controlled with high precision. In order to control, with high precision, the position or the velocity of the member to be driven, it is necessary to determine control parameters of the motor based on the inertia of a movable portion including the member to be driven and the motor. However, the inertia of the movable portion is not constant, and may sometimes vary suitably. For example, in the case of the spindle of the machine tool, when the workpiece attached to the spindle is changed, the inertia of the movable portion as a whole changes.

Because of this, in the related art, techniques have been proposed for estimating the inertia of the movable portion at all times. For example, JP 6009397 B discloses a technique for calculating the inertia of the movable portion from a ratio between an integrated value of a torque command value and an integrated value of an acceleration detection value when the member to be driven is acceleration/deceleration-driven. According to the technique of JP 6009397 B, the inertia of the movable portion can be estimated with a certain degree of accuracy.

An inertia estimation value inevitably includes an estimation error. The estimation error becomes large as a gear ratio which is a ratio of an output-side velocity of the movable portion with respect to an input-side velocity of the movable portion becomes smaller. In the related art described in JP 6009397 B, this relationship between the gear ratio and the error has not be studied. As a result, in the related art, it has been impossible to estimate the inertia of the movable portion with high precision.

An advantage of the present disclosure lies in provision of an inertia estimation apparatus and an inertia estimation method which can more accurately estimate the inertia of the movable portion.

### SUMMARY

According to one aspect of the present disclosure, there is provided an inertia estimation apparatus that estimates the inertia of a movable portion including a motor, a gearbox, and a member to be driven, the inertia estimation apparatus comprising: a controller configured to estimate the inertia of the movable portion based on an acceleration and an output torque of the motor, and a gear ratio, which is a ratio of an output-side velocity with respect to an input-side velocity, of the gearbox when the motor is caused to perform an acceleration/deceleration operation for estimating inertia, wherein the controller is configured to cause the execution of the acceleration/deceleration operation for estimating the inertia in a state in which the gear ratio is changed to a gear ratio for estimating inertia.

In this case, the gear ratio for estimating the inertia may be a maximum gear ratio of the gearbox.

Further, the gear ratio for estimating the inertia may be a designated gear ratio designated by a user.

The controller may be configured to store, prior to the acceleration/deceleration operation for the estimation, a gear ratio of the gearbox at that point as a pre-start gear ratio, and to change the gear ratio of the gearbox to the pre-start gear ratio after completion of the acceleration/deceleration operation for the estimation.

The controller may be configured to: acquire a first total inertia which is a total inertia-to-motor-shaft in a state in which a workpiece is removed from the member to be driven, and a second total inertia which is a total inertia-to-motor-shaft in a state in which the workpiece is mounted on the member to be driven; and calculate a value obtained by dividing a value obtained by subtracting the first total inertia from the second total inertia by a square of the gear ratio as an estimated workpiece inertia, and the total inertia-to-motor-shaft may be calculated by dividing an integrated value of a torque command of the motor during an integration interval in which the motor is accelerating or decelerating by an integrated value of an acceleration of the motor during the integration interval.

According to another aspect of the present disclosure, there is provided a motor control apparatus comprising the inertia estimation apparatus, wherein the controller is configured to: calculate the inertia of a workpiece mounted on the member to be driven as an estimated workpiece inertia; and change a servo parameter, which is a control parameter of the motor, based on the estimated workpiece inertia.

According to another aspect of the present disclosure, there is provided an inertia estimation method of estimating the inertia of a movable portion including a motor, a gearbox, and a member to be driven, the inertia estimation method comprising: causing the motor to perform an acceleration/deceleration operation for estimating inertia in a state in which a gear ratio, which is a ratio of an output-side velocity with respect to an input-side velocity, of the gearbox is changed to a gear ratio for estimating inertia; and estimating the inertia of the movable portion based on an acceleration and an output torque of the motor, and the gear ratio when the acceleration/deceleration operation for estimating the inertia is executed.

According to the technique of the present disclosure, the acceleration/deceleration operation for estimating inertia is executed in a state in which the gear ratio is changed to a gear ratio for estimating inertia. Because of this, the estimation error of the inertia of the movable portion can be reduced, and the inertia of the movable portion can be more accurately estimated.

### BRIEF DESCRIPTION OF DRAWINGS

Embodiment(s) of the present disclosure will be described based on the following figures, wherein

FIG. 1 is a block diagram showing a structure of a motor control apparatus;

FIG. 2 is a flowchart showing a flow of calculating an estimated workpiece inertia and setting a servo parameter by the motor control apparatus;

FIG. 3 is a block diagram showing another structure of the motor control apparatus;

FIG. 4 is a flowchart showing a flow of estimating the workpiece inertia and setting the servo parameter by the motor control apparatus illustrated in FIG. 3;

FIG. 5 is a block diagram showing another structure of the motor control apparatus; and

FIG. 6 is a flowchart showing a flow of estimating the workpiece inertia and setting the servo parameter by the motor control apparatus illustrated in FIG. 5.

### DESCRIPTION OF EMBODIMENTS

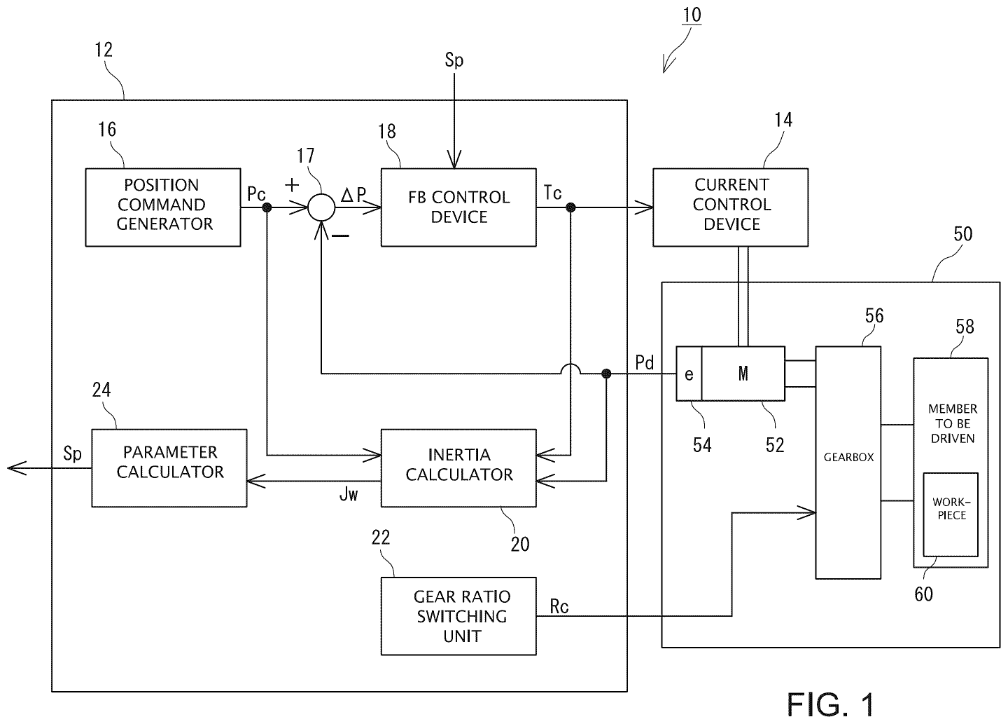

A structure of a motor control apparatus 10 will now be described with reference to the drawings. FIG. 1 is a block diagram showing a structure of the motor control apparatus 10. The motor control apparatus 10 controls driving of a motor 52. The motor 52 is mechanically connected to a member to be driven 58 via a gearbox 56. The member to be driven 58 includes a workpiece 60 which can be attached and detached, and which can also be exchanged. In the following, the motor 52, the member to be driven 58, and the gearbox 56 will be collectively referred to as a “movable portion 50”. The movable portion 50 can be viewed as a movable portion of various apparatuses. For example, the movable portion 50 may be a movable portion of a machine tool such as, for example, a spindle of a lathe. In this case, the workpiece which is attached to the spindle and machined by the machine tool corresponds to the workpiece 60 illustrated in FIG. 1.

A position sensor 54 detects a position of the motor 52 or the member to be driven 58. The position sensor 54 is, for example, an encoder which optically or electromagnetically detects the position of the motor 52 or the member to be driven 58. The position of the motor 52 or the member to be driven 58 detected by the position sensor 54 is output to the motor control apparatus 10 as a position detection value Pd.

As described above and illustrated in FIG. 1, the movable portion 50 includes the gearbox 56. The gearbox 56 changes a gear of an output motive power of the motor 52 and transmits power to the member to be driven 58. The gearbox 56 of the present embodiment can change a gear ratio R stepwise or continuously. The gear ratio R is a ratio of an output-side velocity m with respect to an input-side velocity n. That is, R=m/n. In the following, the maximum gear ratio among the gear ratio R which can be selected at the gearbox 56 will be referred as a “maximum gear ratio Rmx”. Such a gearbox 56 includes, for example, a gear, a pulley, a clutch, or a combination of these. In addition, the gearbox 56 may have an electrically-driven actuator (not shown) for automatically switching the gear ratio R. The electrically-driven actuator changes the gear ratio R, for example, by receiving a command from a gear ratio switching unit 22 to be described below and switching a clutch or the like.

The motor control apparatus 10 controls a position or a velocity of the motor 52, and, consequently, the position or the velocity of the member to be driven. The motor control apparatus 10 can generally be divided into a controller 12 and a current control device 14. The current control device 14 is electrically connected to a power supply (not shown) and controls a current applied to the motor 52 in response to a torque command Tc which is output from the controller 12. The current control device 14 is, for example, an inverter.

The controller 12 controls the driving of the motor 52 in response to a control command which is input from a higher-level control apparatus. The controller 12 functions also as an inertia estimation apparatus which estimates inertia. Physically, the controller 12 is a computer having one or more processors and a memory. For example, when the movable portion 50 is the spindle of the machine tool, the controller 12 may be a numerical control apparatus incorporated in the machine tool, or a controller of the machine tool.

As illustrated in FIG. 1, the controller 12 is configured to function as a position command generator 16, a subtractor 17, an FB control device 18, an inertia calculator 20, the gear ratio switching unit 22, and a parameter calculator 24. The position command generator 16 outputs a position command value Pc in response to a control command from a higher-level control apparatus. The subtractor 17 outputs a value obtained by subtracting the position detection value Pd which is output from the position sensor 54 from the position command value Pc, as a position difference ΔP.

The FB control device 18 calculates the torque command Tc based on the position difference ΔP. For example, the FB control device 18 may calculate the torque command Tc through PID control. That is, the FB control device 18 may multiply the position difference ΔP, an integrated value of the position difference ΔP, and a differential value of the position difference ΔP respectively by a proportional gain, an integration gain, and a differentiation gain, and calculate a sum of the resulting values as the torque command Tc. A form of calculation of the torque command Tc by the FB control device 18 is not particularly limited and can be suitably changed.

The controller 12 further functions as the inertia calculator 20, the parameter calculator 24, and the gear ratio switching unit 22. The reason for employing such a structure will now be described. The torque command Tc described above is a manipulation quantity for the motor 52. Coefficients used for calculating this manipulation quantity, for example, the proportional gain and the integration gain, are parameters for controlling the motor 52; that is, a servo parameter Sp. In order to accurately control the position or the velocity of the motor 52 or the member to be driven 58, the servo parameter Sp must be set to a value corresponding to the inertia of the movable portion 50. However, the inertia of the movable portion 50 changes according to the type of the workpiece 60 mounted on the member to be driven 58. Thus, in order to set a suitable servo parameter Sp, the controller 12 of the present embodiment calculates an estimated workpiece inertia Jw′, and changes the servo parameter Sp, periodically or non-periodically. The calculation of the estimated workpiece inertia Jw′ will now be described in detail.

As is well known, a torque t is a multiplied value of the inertia J and the acceleration a and is represented by Equation 1.

$$τ = J \times α \qquad ( Equation 1 )$$

When the inertia is to be estimated, the above-described Equation 1 is used. More specifically, when the inertia is to be estimated, the position command generator 16 outputs a position command value Pc to cause an acceleration/deceleration operation of the movable portion 50. The inertia calculator 20 sets an interval during which the movable portion 50 is accelerating or decelerating as an integration interval and calculates a total inertia to motor shaft J from the motor torque t and the acceleration a during the integration interval. Specifically, the total inertia to motor shaft J is a value obtained by dividing an integrated value of the motor torque t during the integration interval by an integrated value of the acceleration a of the motor 52 during the integration interval and is represented by Equation 2. The acceleration a is acquired by, for example, twice differentiating the position detection value Pd.

$$J = \frac{\int ( τ ) dt}{\int ( α ) dt} = \frac{{K}_{t} \cdot \int ( i ) dt}{\int ( α ) dt} \qquad ( Equation 2 )$$

In the following, the total inertia to motor shaft when the workpiece 60 is not mounted on the member to be driven 58 will be referred to as a “first total inertia Jt”, and the total inertia to motor shaft J when the workpiece 60 is mounted will be referred to as a “second total inertia Jh”. Here, the second total inertia Jh is a value obtained by adding the first total inertia Jt and a value obtained by multiplying the workpiece inertia Jw by a square of the gear ratio R. That is, the second total inertia Jh is represented by the following Equation 3.

$$Jh = Jt + Jw \times R 2 \qquad ( Equation 3 )$$

Therefore, the estimated workpiece inertia Jw′ can be determined as shown by Equation 4, by dividing a value obtained by subtracting the first total inertia Jt from the second total inertia Jh by the square of the gear ratio R.

$${Jw}^{′} = ( Jh - Jt ) / R 2 \qquad ( Equation 4 )$$

The first total inertia Jt can be acquired by causing the acceleration/deceleration operation of the movable portion 50 in a state in which the workpiece 60 is removed from the member to be driven 58 and applying the motor torque t and the acceleration a at this point to Equation 2. Similarly, the second total inertia Jh can be acquired by causing the acceleration/deceleration operation of the movable portion 50 in a state in which the workpiece 60 is mounted on the member to be driven 58 and applying the motor torque t and the acceleration a at this point to Equation 2.

The estimated workpiece inertia Jw′ calculated through Equation 4 inevitably includes an estimation error. The estimation error becomes larger as the gear ratio R becomes smaller. This point will now be explained. When an inertia estimation error rate of the first total inertia Jt which occurs due to variation of the motor torque constant or the like is At, an inertia estimation error rate of the second total inertia Jh is Ah, and a true value of the workpiece inertia is Jw, the estimated workpiece inertia Jw′ taking the error into consideration is represented by Equation 5.

$${J}_{w}^{′} = \frac{( 1 + {A}_{h} ) \cdot {J}_{h} - ( 1 + {A}_{t} ) \cdot {J}_{t}}{{R}^{2}} = {J}_{w} + \frac{{A}_{h} \cdot {J}_{h} - {A}_{t} \cdot {J}_{t}}{{R}^{2}} \qquad ( Equation 5 )$$

Therefore, an error rate B of the estimated workpiece inertia Jw′ with respect to the true value Jw can be represented by Equation 6. As is clear from Equation 6, the error rate B is inversely proportional to the square of the gear ratio R. Thus, as the gear ratio R becomes smaller, the denominator on the right side of Equation 6 becomes smaller, and the error rate B becomes larger.

$$B = \vert \frac{{J}_{w}^{′} - {J}_{w}}{{J}_{w}} \vert = \vert \frac{{A}_{h} {J}_{h} - {A}_{t} {J}_{t}}{{J}_{w}} \cdot \frac{1}{{R}^{2}} \vert \qquad ( Equation 6 )$$

When the servo parameter Sp is changed using the total inertia to motor shaft J in place of the workpiece inertia Jw, the error rate is constant regardless of the gear ratio R. However, when the total inertia to motor shaft J is used, the total inertia-to-motor-shaft J must be calculated for each gear ratio R which can be selected at the gearbox 56. In addition, during a process of calculating, based on a total inertia-to-motor-shaft J1 calculated with a particular gear ratio R1, a total inertia-to-motor-shaft J2 calculated at a different gear ratio R2, the workpiece inertia Jw described above must be calculated. Moreover, when the total inertia-to-motor-shaft J is used, it is necessary to store in a correlated manner the total inertia-to-motor-shaft J and the gear ratio during the calculation of the total inertia-to-motor-shaft J. Thus, the control becomes complicated. In consideration of these circumstances, it is more advantageous to use the workpiece inertia Jw instead of the total inertia-to-motor-shaft J. As such, in the present embodiment, the servo parameter Sp is changed based on the workpiece inertia Jw, and not on the total inertia-to-motor-shaft J.

As described above, the error rate B of the estimated workpiece inertia Jw′ becomes larger as the gear ratio R becomes smaller. Thus, the motor control apparatus 10 of the present disclosure has the gear ratio switching unit 22 which switches the gear ratio R to the maximum gear ratio Rmx prior to the estimation of the workpiece inertia Jw. That is, the motor control apparatus 10 uses the maximum gear ratio Rmx as a gear ratio for estimating the workpiece inertia Jw. The gear ratio R is changed to the maximum gear ratio Rmx by outputting an electric signal for switching the gear ratio R to the gearbox 56 prior to causing the movable portion 50 to execute the acceleration/deceleration operation for estimating inertia. The inertia calculator 20 applies the motor torque t and the acceleration a acquired in the state of R=Rmx, and the maximum gear ratio Rmx to Equation 2 and Equation 4 and calculates the estimated workpiece inertia Jw′. With this process, the error rate B can be kept low, and the estimated workpiece inertia Jw′ can be estimated more accurately.

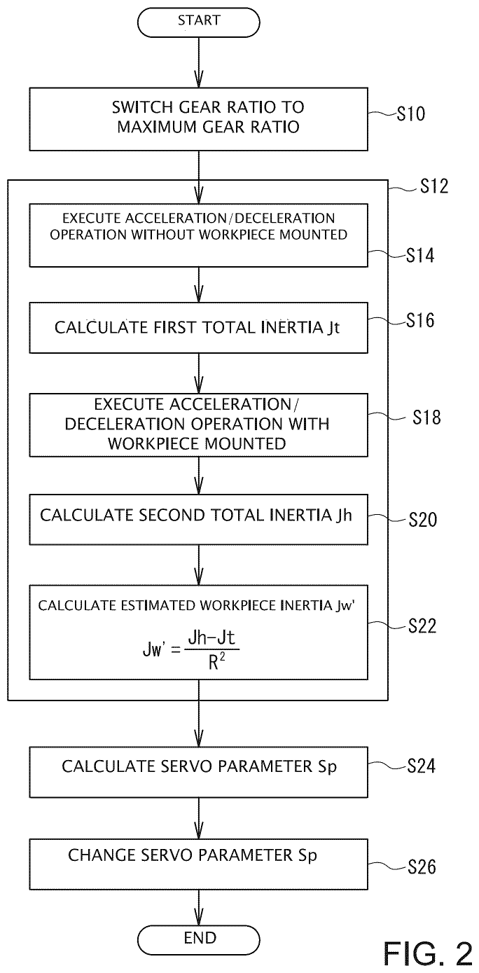

FIG. 2 is a flowchart showing a flow of calculating the estimated workpiece inertia Jw′ and setting the servo parameter Sp by the motor control apparatus 10. The process illustrated in FIG. 2 may be executed, for example, at a timing designated by the user, or may be executed automatically by the controller 12. For example, when the movable portion 50 is the machine tool, the controller 12 may automatically start the process of FIG. 2 based on a progress situation of a machining program which is being executed by the machine tool. For example, the controller 12 may automatically execute the process of FIG. 2 at a timing when a change of the type of the workpiece to be machined by the machine tool is commanded in the machining program.

When the controller 12 changes the servo parameter Sp, the controller 12 first switches the gear ratio R of the gearbox 56 to the maximum gear ratio Rmx (S10). Then, the controller 12 executes the inertia estimation process in this state (S12). Specifically, the controller 12 causes the movable portion 50 to execute the acceleration/deceleration operation in a state in which the workpieces 60 is removed from the member to be driven 58 (S14). For example, the controller 12 stores data of the position command value Pc which causes acceleration or deceleration of the movable portion 50 as an estimation profile, and generates, during the inertia estimation, the position command value Pc based on this estimation profile. Alternatively, the controller 12 may detect whether or not the workpiece 60 is mounted on the member to be driven 58 prior to the acceleration/deceleration operation, and may present to the user a message to prompt removal of the workpiece 60 when the workpiece 60 is mounted.

Then, the controller 12 calculates the total inertia to motor shaft in a state in which the workpiece 60 is not mounted; that is, the first total inertia Jt, based on the position detection value Pd and the torque command Tc collected during the execution of the acceleration/deceleration operation (S16). Specifically, the controller 12 collects the position detection value Pd and the torque command Tc during the execution of the acceleration/deceleration operation. The controller 12 calculates the acceleration by twice differentiating the position detection value Pd and identifies an interval of acceleration or deceleration as the integration interval based on the value of the acceleration. The controller 12 calculates, based on Equation 2, a value obtained by dividing the integrated value of the motor torque τ during the integration interval by the integrated value of the acceleration a of the motor 52 during the integration interval, as the first total inertia Jt.

With regard to the value of the first total inertia Jt; that is, the total inertia-to-motor-shaft in the state in which the workpiece 60 is removed, an apparent inertia value may slightly change due to a change of sliding resistance which may occur in units of several years, but there is almost no change of the value in short term. In consideration of this, steps S14 and S16 of FIG. 2 may be omitted, and a value which is calculated in advance may be used as the first total inertia Jt. In this case, the value of the first total inertia Jt may be updated with a long-term interval (for example, a one-year interval), or after an operation which results in a change of the first total inertia Jt (for example, after exchanging a chuck arrangement).

Once the first total inertia Jt is acquired, the controller 12 acquires the second total inertia Jh (S18, S20). The procedure for acquiring the second total inertia Jh is similar to the procedure for acquiring the first total inertia Jt except that the acceleration/deceleration operation of the movable portion 50 is executed in the state in which the workpiece 60 is mounted, and the procedure will not be repeatedly described in detail. The controller 12 may detect presence or absence of attachment of the workpiece 60 to the member to be driven 58 prior to the start of the acceleration/deceleration operation of step S18 and may present to the user a message to prompt attachment of the workpiece 60 when the workpiece 60 is not mounted.

Once the first total inertia Jt and the second total inertia Jh are acquired, the controller 12 calculates the estimated workpiece inertia Jw′ based on Equation 4 (S22). That is, the controller 12 calculates a value obtained by dividing a value obtained by subtracting the first total inertia Jt from the second total inertia Jh by the square of the gear ratio R as the estimated workpiece inertia Jw′. Here, because the gear ratio R in this process is the maximum gear ratio Rmx, the error rate B can be kept low, as explained above with reference to Equation 6.

Once the estimated workpiece inertia Jw′ is acquired, the controller 12 calculates the servo parameter Sp based on the estimated workpiece inertia Jw′ (S24) and changes the servo parameter Sp to the value after the change (S26). By setting the servo parameter Sp corresponding to the estimated workpiece inertia Jw′ which is thus estimated with high precision, it is possible to control the movable portion 50 with higher precision.

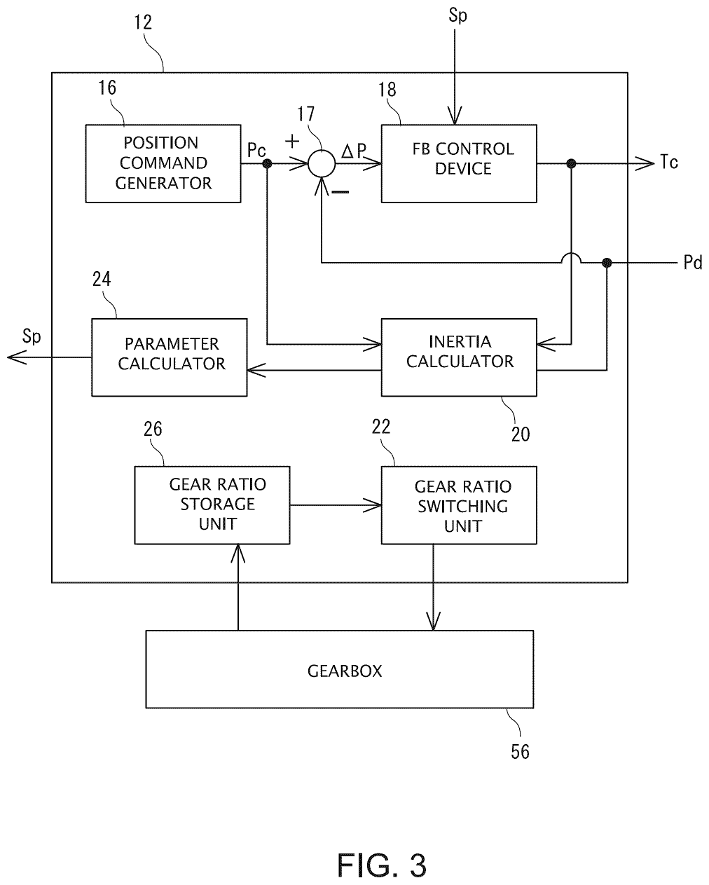

Next, another structure of the motor control apparatus 10 will be described with reference to FIG. 3. FIG. 3 is a block diagram showing another structure of the motor control apparatus 10. The motor control apparatus 10 differs from the motor control apparatus 10 illustrated in FIG. 1 in that the controller 12 also functions as a gear ratio storage unit 26. The gear ratio storage unit 26 stores the gear ratio R before the gear ratio R of the gearbox 56 is switched to the maximum gear ratio Rmx as a pre-start gear ratio Ra. The gear ratio switching unit 22 acquires, once the acquisition of the estimated workpiece inertia Jw′ is completed, the pre-start gear ratio Ra stored in the gear ratio storage unit 26, and switches the gear ratio R from the maximum gear ratio Rmx back to the pre-start gear ratio Ra.

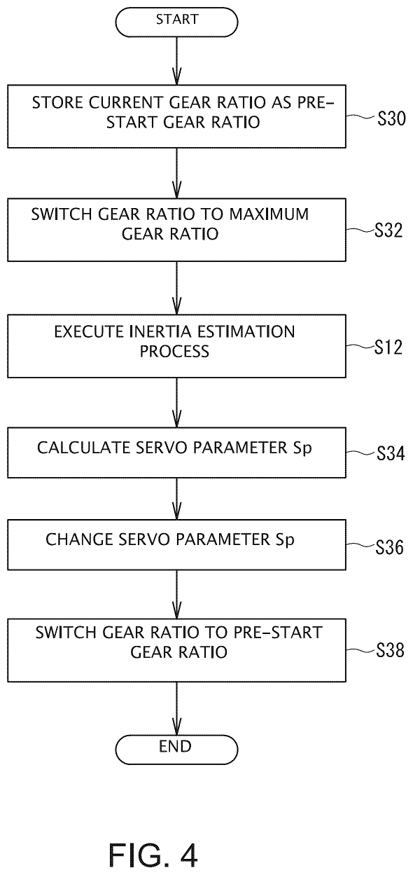

FIG. 4 is a flowchart showing a flow of the calculating the estimated workpiece inertia Jw′ and changing the servo parameter Sp by the motor control apparatus 10 illustrated in FIG. 3. As illustrated in FIG. 4, in this case, prior to switching the gear ratio R to the maximum gear ratio Rmx (S32), the controller 12 stores a current gear ratio R of the gearbox 56 as the pre-start gear ratio Ra (S30). Then, the controller 12 switches the gear ratio R to the maximum gear ratio Rmx (S32) and executes the inertia estimation process in this state (S12). As the contents of the inertia estimation process are identical to steps 14 to S22 of FIG. 2, the inertia estimation process will not be repeatedly described in detail.

Once the estimated workpiece inertia Jw′ is calculated, the controller 12 executes the calculation and the change of the servo parameter Sp based on the acquired estimated workpiece inertia Jw′ (S34, S36). Finally, the controller 12 switches the gear ratio R of the gearbox 56 to the pre-start gear ratio Ra (S38).

With such a structure, while the servo parameter Sp can be appropriately set, a gear state desired by the user can be maintained. That is, in the present embodiment, the gear ratio R is forcibly changed to the maximum gear ratio Rmx in order to acquire the estimated workpiece inertia Jw′. However, when the gear ratio R is changed, the output torque and the velocity range of the member to be driven 58 also change. For example, when the movable portion 50 is the spindle of the machine tool, if the output torque and the velocity range change, machining desired by the user cannot be performed. Thus, in the present configuration, once the estimated workpiece inertia Jw′ is acquired, the gear ratio R is returned to the original state. With this configuration, the movable portion 50 can be operated in a state desired by the user after the estimated workpiece inertia Jw′ is acquired.

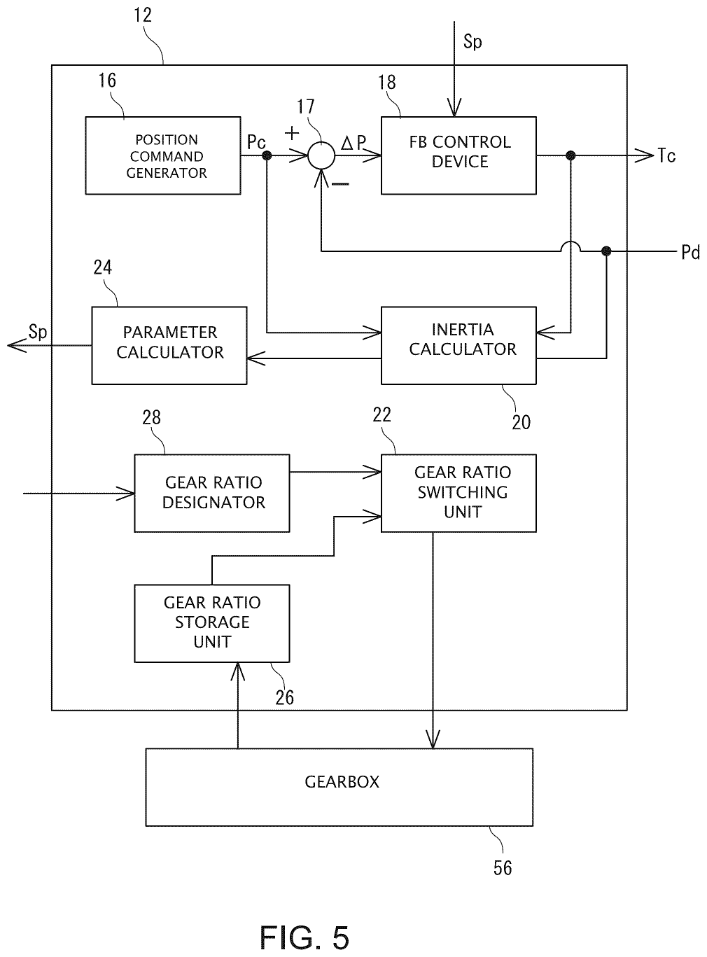

Next, another structure of the motor control apparatus 10 will be described with reference to FIG. 5. FIG. 5 is a block diagram showing another structure of the motor control apparatus 10. The motor control apparatus 10 differs from the motor control apparatus illustrated in FIG. 3 in that the controller 12 further functions as a gear ratio designator 28.

The gear ratio designator 28 determines the gear ratio used for the estimation of the workpiece inertia Jw; that is, an estimation gear ratio, and notifies the estimation gear ratio to the gear ratio switching unit 22. That is, as described above, in order to reduce the error rate B of the estimated workpiece inertia Jw′, the gear ratio R may be increased to the highest possible value. However, due to deficiency of machines or the like, there may be cases where the maximum gear ratio Rmx cannot be selected. In such cases, the gear ratio designator 28 determines a gear ratio designated by the user as the estimation gear ratio.

For example, the gear ratio designator 28 may store in advance a gear ratio designated by the user as a designated gear ratio Rb and determine the designated gear ratio Rb as the estimation gear ratio when commanded by the user or when the maximum gear ratio Rmx cannot be used. In another configuration, the gear ratio designator 28 may inquire the user of the necessity of setting of the designated gear ratio Rb every time the workpiece inertia Jw is estimated. When there is an input of the designated gear ratio Rb by the user, the gear ratio designator 28 may determine the designated gear ratio Rb as the estimation gear ratio, and, when there is no such an input, the gear ratio designator 28 may determine the maximum gear ratio Rmx as the estimation gear ratio. When the workpiece inertia Jw is estimated, the gear ratio switching unit 22 switches the gear ratio R of the gearbox 56 to the notified estimation gear ratio.

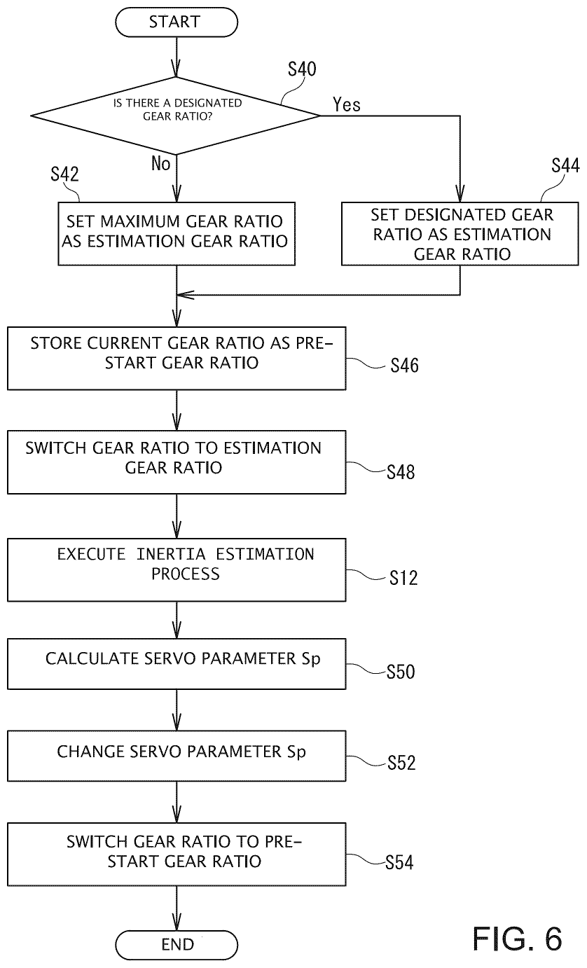

FIG. 6 is a flowchart showing a flow of calculating the estimated workpiece inertia Jw′ and changing the servo parameter Sp by the motor control apparatus 10 illustrated in FIG. 5. As illustrated in FIG. 6, in this case, prior to switching the gear ratio R (S48), the controller 12 checks the necessity of employing the designated gear ratio Rb (S40). The controller 12 judges that the employment of the designated gear ratio Rb is necessary when the maximum gear ratio Rmx cannot be used or when the user commands the use of the designated gear ratio Rb (Yes in S40). In this case, the controller 12 sets the designated gear ratio Rb as the estimation gear ratio (S44). On the other hand, when the employment of the designated gear ratio Rb is not necessary, the controller 12 sets the maximum gear ratio Rmx as the estimation gear ratio (S42).

Next, the controller 12 stores a current gear ratio as the pre-start gear ratio Ra in the gear ratio storage unit 26 (S46). Then, the controller 12 switches the gear ratio R to the estimation gear ratio (S48) and executes the inertia estimation process in this state (S12). As the contents of the inertia estimation process (S12) are identical to steps S14 to S22 of FIG. 2, the inertia estimation process will not be repeatedly described in detail. In addition, as the processes after the calculation of the estimated workpiece inertia Jw′ (S50 to S54) are identical to S34 to S38 of FIG. 4, these processes also will not be repeatedly described in detail.

As described, in the present configuration, because the workpiece inertia Jw can be estimated with the gear ratio R designated by the user, the workpiece inertia Jw can be appropriately estimated even when the maximum gear ratio Rmx cannot be selected due to the deficiency of machines or the like.

The structures described above are merely exemplary, and, so long as the structures of the independent claim are provided, the other structures may be altered. For example, in the above description, the total inertia to motor shaft is calculated by dividing the integrated value of the torque command Tc of the motor 52 during the integration interval in which the motor 52 is accelerating or decelerating by the integrated value of the acceleration a of the motor 52 during the integration interval. Alternatively, so long as the total inertia to motor shaft can be acquired, the calculation formula may be suitably altered. Further, in the above description, the servo parameter Sp is changed based on the estimated workpiece inertia Jw′. However, alternatively, the servo parameter Sp may be changed in consideration of other parameters, in addition to the estimated workpiece inertia Jw′.

### REFERENCE SIGNS LIST

10 motor control apparatus, 12 controller, 14 current control device, 16 position command generator, 17 subtractor, 18 FB control device, 20 inertia calculator, 22 gear ratio switching unit, 24 parameter calculator, 26 gear ratio storage unit, 28 gear ratio designator, 50 movable portion, 52 motor, 54 position sensor, 56 gearbox, 58 member to be driven, 60 workpiece, Jw workpiece inertia, Jw′ estimated workpiece inertia, R gear ratio, Ra pre-start gear ratio, Rb designated gear ratio, Rmx maximum gear ratio, Sp servo parameter.

1. An inertia estimation apparatus that estimates the inertia of a movable portion including a motor, a gearbox, and a member to be driven, the inertia estimation apparatus comprising:
a controller configured to estimate the inertia of the movable portion based on an acceleration and an output torque of the motor, and a gear ratio, which is a ratio of an output-side velocity with respect to an input-side velocity, of the gearbox when the motor is caused to perform an acceleration/deceleration operation for estimating inertia, wherein
the controller is configured to cause the execution of the acceleration/deceleration operation for estimating the inertia in a state in which the gear ratio is changed to a gear ratio for estimating inertia.

2. The inertia estimation apparatus according to claim 1, wherein
the gear ratio for estimating the inertia is a maximum gear ratio of the gearbox.

3. The inertia estimation apparatus according to claim 1, wherein
the gear ratio for estimating the inertia is a designated gear ratio designated by a user.

4. The inertia estimation apparatus according to claim 1, wherein
the controller is configured to store, prior to the acceleration/deceleration operation for the estimation, a gear ratio of the gearbox at that point as a pre-start gear ratio, and to change the gear ratio of the gearbox to the pre-start gear ratio after completion of the acceleration/deceleration operation for the estimation.

5. The inertia estimation apparatus according to claim 1, wherein
the controller is configured to:
acquire a first total inertia which is a total inertia-to-motor-shaft in a state in which a workpiece is removed from the member to be driven, and a second total inertia which is a total inertia-to-motor-shaft in a state in which the workpiece is mounted on the member to be driven; and
calculate a value obtained by dividing a value obtained by subtracting the first total inertia from the second total inertia by a square of the gear ratio as an estimated workpiece inertia, and
the total inertia to motor shaft is calculated by dividing an integrated value of a torque command of the motor during an integration interval in which the motor is accelerating or decelerating by an integrated value of an acceleration of the motor during the integration interval.

6. A motor control apparatus comprising
the inertia estimation apparatus according to claim 1, wherein
the motor control apparatus controls driving of the motor, and
the controller is configured to:
calculate the inertia of a workpiece mounted on the member to be driven as an estimated workpiece inertia; and
change a servo parameter, which is a control parameter of the motor, based on the estimated workpiece inertia.

7. An inertia estimation method of estimating the inertia of a movable portion including a motor, a gearbox, and a member to be driven, the inertia estimation method comprising:
causing the motor to perform an acceleration/deceleration operation for estimating inertia in a state in which a gear ratio, which is a ratio of an output-side velocity with respect to an input-side velocity, of the gearbox is changed to a gear ratio for estimating inertia; and
estimating the inertia of the movable portion based on an acceleration and an output torque of the motor, and the gear ratio when the acceleration/deceleration operation for estimating the inertia is executed.
